(19) United States
(12) Patent Application Publication
(10) Pub. No.: US 2018/0111411 A1
(43) Pub. Date: Apr. 26, 2018

(54) Unitary cup-like holder device that attaches to a paint can for holding a paint brush or other implement

(71) Applicant: CARLOS JIMENEZ, OCEANSIDE, CA (US)

(72) Inventor: CARLOS JIMENEZ, OCEANSIDE, CA (US)

(21) Appl. No.: 15/330,652

(22) Filed: Oct. 24, 2016

(51) Int. Cl. B44D 3/12

(52) U.S. Cl. CPC B44D 3/123

(57) ABSTRACT

A basically rectangular and curved unitary cup-like holder device having front and rear walls, two side walls and an outwardly flared open top. Said device having two curved opposing congruent longitudinal flanges each flange having a hooking element in close proximity to their termination to receive the corresponding projection of a paint can's wire handle ears whereupon the unitary cup-like holder device engages and becomes securely coupled to the wire handle ears of a paint can. The elements or embodiments of this invention cooperate towards a unitary result. The longitudinal curved flanges with hooking elements, flexible tabs and apertures, upper rear wall tabs, lower elongated support members and protruding cleats all work in conjunction to the means of attaching this unitary cup-like holder device to a paint can strongly and securely, without the dependency of the rim of the paint can.

### CROSS REFERENCE TO RELATED APPLICATIONS

Application No. 62/389,965

Filing Date: Mar. 14, 2016

### FEDERALLY SPONSORED RESEARCH

Not Applicable

### SEQUENCE LISTING OR PROGRAMS

Not Applicable

### BACKGROUND OF THE INVENTION

Prior art discloses an abundance of holders of various configurations and designs for attachment onto paint cans for placement or holding paint brushes or painting implements. Prior art disclosures cite devices comprised of assemblies hanging or suspended over or upon the rim of a paint can, attaching to a paint can by straps or clips and yet others that suspend paint brushes within the open paint can. All of which are dependent on being supported by or hung upon the rim of a paint can creating a problem by obstructing the rim of a paint can. This novel and innovative device solves the unresolved and inconvenient problem of obstructing the rim of a paint can, by providing an alternative, novel and different paint brush or other implement holder without obstructing the rim of a paint can. Said device is comprised of a cup-like part with flanges on either side, having an arcuate rear wall designed to go around the vertical surface of a paint can and hook onto the paint can's wire handle ears, allowing the paint can's rim to remain unfettered for convenient replacement of the lid of a paint can. Said device concurrently provides a place for stowing a brush or such implement temporarily while taking a break from the work or longer term after completion of the work. This device is particularly useful after a paint project is completed to stow a brush in the unitary cup-like holder device while said device remains attached to the paint can, providing a place to maintain the association of a particular brush with a particular type paint finish.

This unitary cup-like holder device can be constructed as disposable, and reusable and of variations of plastic or metal materials. Said device differs physically and operationally from previously disclosed prior art. Several elements or characteristics of this invention present embodiments that are new, unique and produce a novel method of attachment of this device onto a paint can. The present invention teaches several never before seen embodiments that function simultaneously as one unit. Positioning said device onto and hooking the flanges onto the wire handle ears of a paint can, produces a particularly non-obvious and unexpected result; the unitary cup-like holder device attaches and remains securely fastened to a paint can until it is physically removed. While in place, said device does not obstruct the rim of a paint can; and at the same time provides a holder for a brush or other implement, affording the convenience of replacing the paint can lid on the paint can without having to remove said holder device from the paint can. When manufactured it can be desirable to accessorize said device with disposable inserts that can be manufactured to fit within the cup-like part of the unitary holder device.

Prior art devices referenced in this application require dependency of holding straps or use of an open paint can's rim, and don't appear to present an opportunity to replace the lid on the paint can or such receptacle while prior art devices remain in place. For example U.S. Pat. No. 5,322,183 issued to David G. Strachan in August 1991 relates to a paint brush receptacle adapted to engage the peripheral edge of an open paint can. U.S. Pat. No. 7,500,580B2 issued December 2009 to Shannon W. Hawkins for supporting a paint brush on an open top paint container. U.S. Pat. No. 2005/0145764 issued July 2005 to Dennis Cudney teaches a container device to be attached to a paint can wherein the means for securing said container is a strap or the paint can wire handle. U.S. Pat. No. 2007/0102436 issued May 2007 to Anthony Peccon discloses a paint brush holder comprising a lip on said receptacle for hanging on an upper rim of an open paint container. U.S. Pat. No. 2005/0000971 issued to Angelo Kourmarianos in July 2002, claims a paint brush pocket cooperative with an open paint can depending therefrom within said open paint can. U.S. Pat. No. 4,101,046 issued to Theodore F. Puntillo in May 1977 cites a device or apparatus with a base having a lip which is complemental to the chime of a paint can. U.S. Pat. No. 3,407,429 issued to L. A. Di Nardo in October 1968 also cites a paint brush holder utilizing and engaging the rim of the paint can to suspend the brush holder.

### SUMMARY OF THE INVENTION

A unitary cup-like holder device designed to go around the vertical surface of a paint can and hook onto the paint can's ears. Said device comprised of a cup-like part basically rectangular with a slight taper from top to bottom and having a front and rear wall, two sides, a bottom and an open outwardly flared top. Said device having a rear wall curvature along the entirety of the unitary holder device, that is designed to go around the vertical surface of a paint can and hook onto the paint can's ears. Said device wherein one or more tabs and apertures along the top rear wall surface extend from the device toward the paint can and flex against the paint can when the holder device is attached to paint can causing a tighter fit. The unitary cup-like holder device having two opposing congruent curved side flanges extending longitudinal from the rear wall of said device. Each of the two congruent side flanges having a hooking aspect in close proximity to their termination to receive and hook onto the corresponding projection of a paint can's wire handle ears. When the hooking elements of the side flanges engage the paint can's wire handle ears, that engagement becomes the holding strength of the unitary holder device upon the paint can. Each of the two, curved opposing congruent side flange having an outwardly curved pull tab at their termination for release of the unitary holder device from the paint can's wire handle ears. Each of the two opposing curved longitudinal congruent side flanges having lower elongated support members of equal length on each side of the cup-like part of unitary holder device. Each of the lower elongated support members having a protruding cleat on the inside bottom edge periphery wherein the elongated support members extend from the device toward the paint can and flex against the paint can when the holder device is attached to the the ears of a paint can to cause a tighter fit. The unique features of the unitary cup-like holder device wherein one or more tabs or apertures along the top rear wall are designed so that they flex against the surface of the paint can and ride up and over the external top protruding lip of the paint can as the device is being attached causing the device to be held securely just below the top external protruding lip of the paint can. This placement or simultaneous positioning produces a tight and secure fit onto the paint can.

An additional cup-like holder device more clearly identified within this submission, not independent and distinct and not uncommon in design, related but distinct invention is the disclosure of a similar child device that was born from the design of it's parent unitary holder cup-like device. Said device comprised of a cup-like holder device having a front wall and two closed side walls a bottom wall and a rear wall having a curvature designed to conform with the curvature of a paint can, said device to be placed upon the exterior vertical surface of a gallon or smaller size paint can with commonly used double backed adhesive tapes. Said device provides a solution to a problem not addressed by prior art in that said device can be placed upon a paint can without encumbering the rim of a paint can to allow for the lid to be replaced on the paint can at any time during or after a painting project. When said device is manufactured it can be desirable to accessorize with disposable inserts.

### BRIEF DESCRIPTION OF SEVERAL VIEWS OF THE DRAWINGS

It is an intent of this disclosure to provide an improvement over prior art by the attachment to a paint can in a different, effective, novel and innovative way. As illustrated in FIGS. 1 through 7, several embodiments of the invention will be more clearly identified in the following description. The features of the invention will be better understood by the reference to the accompanying drawings which illustrate preferred embodiments of the invention. In the drawings:

FIG.1 is a perspective view of the unitary cup-like holder device illustrating several embodiments of the invention; the rear wall curvature, apertures, tabs, lower elongated support members, and curved opposing longitudinal congruent side flanges.

FIG. 2 is a perspective top view of the unitary cup-like holder device illustrating an additional embodiment; wherein each of the tabs on the rear wall has protruding cleats along the top edge periphery of said tabs. An additional embodiment are the outwardly curved ends of the opposing longitudinal congruent side flanges to serve as pull tabs for disengaging the holder device from the paint can's wire handle ears.

FIG. 3 is a perspective front view of the unitary cup-like holder device illustrating an additional embodiment; the lower elongated support members of equal length on each side of the holder device. Each of the lower elongated support members having a protruding cleat on the inside bottom edge periphery.

FIG. 4 is a perspective side view illustrating the main embodiment of the unitary cup-like holder device; the opposing longitudinal congruent curved side flanges extending from the curved rear wall of said device each having a hooking element in close proximity to the termination of the flanges and of sufficient length to allow each of the hooking elements to receive the corresponding projection of a paint can's wire handle ears whereupon engagement of the hooking elements with the paint can's wire handle ears becomes the primary holding feature of the invention.

FIG. 5 is a perspective back view of the unitary holder device, illustrating the apertures and tabs along the center proximity of the unitary cup-like holder rear wall and also illustrating the protruding cleats of the rear wall tabs as well as the cleats along the inside bottom periphery of the lower elongated support members.

FIG. 6 is a front view of a child of the parent unitary cup-like holder device. The child variation can be positioned on any size paint can but of particular use for smaller than 1 gallon paint cans. The unitary cup-like holding device having a curved rear wall, closed bottom wall, two closed side walls and a flared top opening.

FIG. 7 is a perspective side view of the child of the parent unitary cup-like holder device as it is attached to a paint can. The attachment can be achieved with commonly used adhesive double backed tape.

### DETAILED DESCRIPTION OF THE INVENTION

An essentially rectangular unitary holder device slightly tapered from top to bottom, for holding a paint brush or other implement wherein said device comprised of a cup-like part with flanges on either side designed to go around the vertical surface of a paint can and hook onto the paint can's wire handle ears. Said device having front and rear walls, two closed sides, a closed bottom and an open outwardly flared top. The curved rear wall having opposing longitudinal congruent side flanges having a curvature designed to go around the vertical surface of a paint can and hook onto the paint can's wire handle ears. Wherein one or more tabs or apertures extend from the device toward the paint can and flex against the paint can when the holder device is attached to a paint can to cause a tighter fit.

An additional embodiment of said holder are two lower elongated support members on each side of said holder, of equal length, each having protruding cleats on the inside bottom edge periphery. Said cleats are designed so that they flex against the surface of the paint can when the holder device is attached to a paint can to cause a tighter fit.

FIG. 1 is a perspective view illustrating a front view of the unitary cup-like holder device comprised of a front 10 and curved rear wall 15, two side walls 19 a bottom closed wall 21 and an outwardly flared open top 20 and having two opposing congruent longitudinal curved side flanges 11 extending from the sides 19 of said device. The rear wall 15 having several apertures 17 forming several rear wall tabs 16.

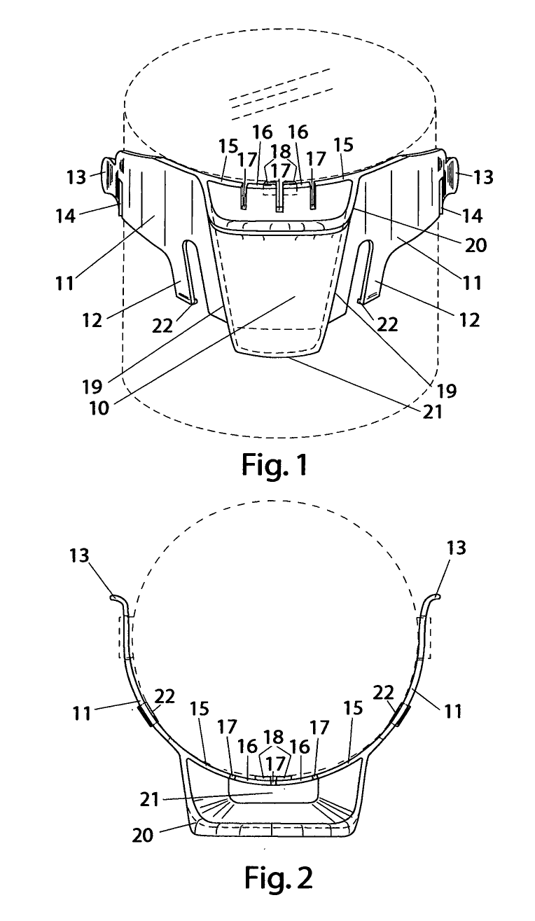

FIG. 2 is an illustration of a perspective top view of the unitary cup-like holder device having two opposing congruent curved side flanges 11 each having outwardly curved pull tabs 13 at the termination of 11 and cleats 18 on the tabs of the rear wall 15.

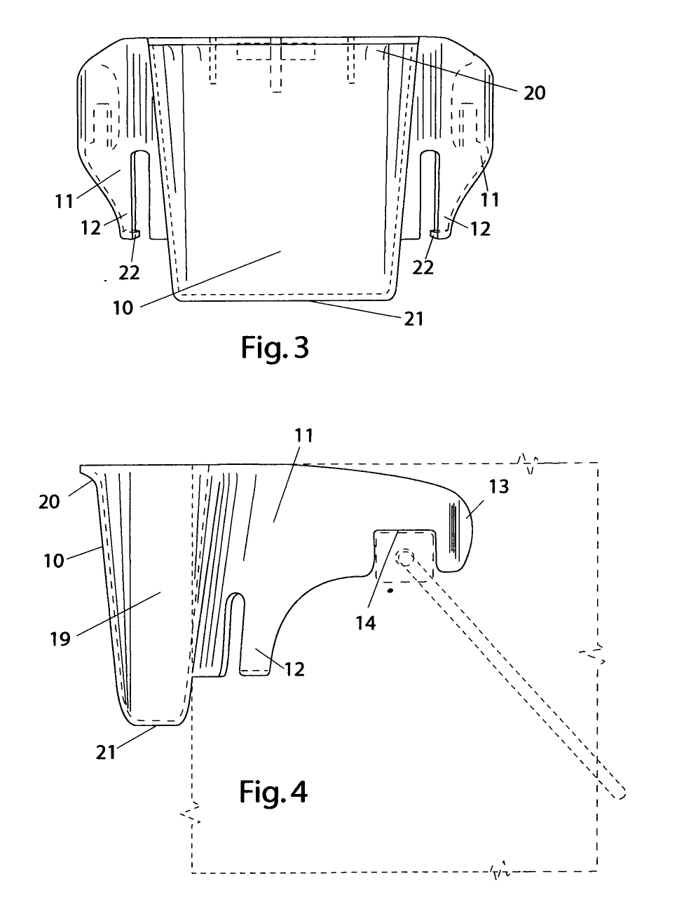

FIG. 3 is an illustration of a perspective front view of the unitary cup-like holder device showing the curvature of the open top 20 and showing opposing congruent curved side flanges 11 and the backside of the two lower elongated support members 12 each having a cleat 22 along the inside bottom edge periphery of 12.

FIG. 4 is a perspective side view of the unitary cup-like holder device front wall 10 and the closed side wall 19, the closed bottom wall 21, and a side view of one of the opposing curved side flanges 11 shown here with a mortise opening 14 to demonstrate a variation of the hooking element of the side flanges 11, as the side flanges would be connected to the wire handle ears of a paint can.

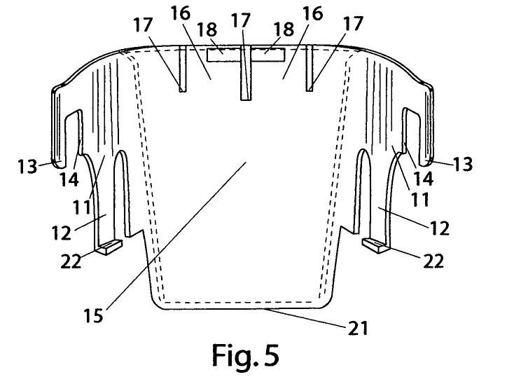

FIG. 5 is a perspective view of the backside of the cup-like holder device illustrating the two lower elongated support members 12 each having a cleat 22 along the inside bottom edge periphery of 12 and illustrates the curved rear wall tabs 16 rear wall apertures 17 and rear wall tab cleats 18.

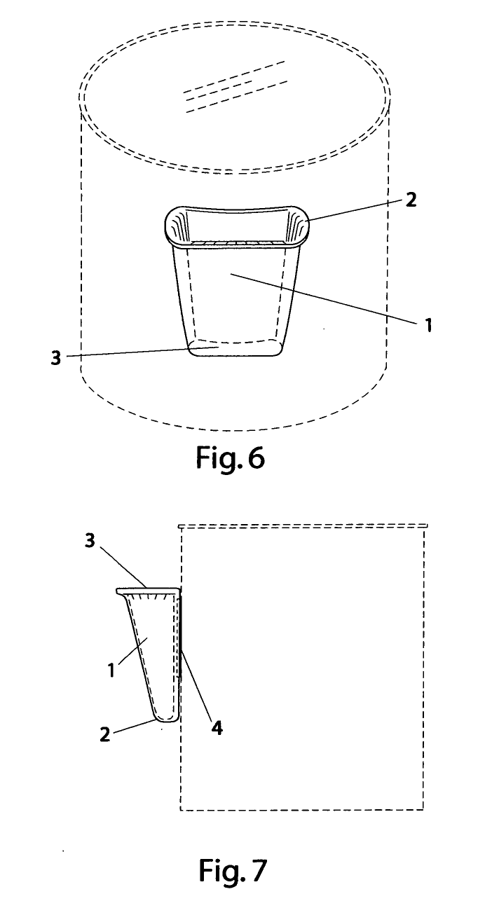

FIG. 6 is a perspective front view of a child of the parent unitary cup-like holder device with a flared top opening 2 and closed bottom 3.

FIG. 7 is a perspective side view of a child of the parent unitary cup-like holder device illustrating a side view 1, closed bottom 2, flared top opening 3 and back side 4 as it would be attached to a paint can.

Conclusions, Ramifications and Scope of the Invention

This invention solves a problem that relevant prior art has not resolved. Prior art disclosures have not resolved the problem created when prior art is hung onto or suspended from the rim of a paint can while the paint can lid is off and the work is in progress. This results in obstructing the rim of the paint can and an inability to replace the lid of the paint can without first removal of such devices. Prior art devices that rest upon and obstruct the rim of a paint can, present a disadvantage. The difference physically and operationally of this of this present invention is that it provides an advantage over prior art in that said device attaches to the exterior of a paint can autonomously without obstructing the rim of the paint can providing an unusual and surprising method of attachment. Wherein one or more tabs or apertures along the top surface of said device are designed so that they flex against the surface of the paint can and ride up and over the protruding external lip of the paint can as the device is being attached causing said device to be held securely just below the protruding external lip of the paint can; thereby securely holding this device on the paint can to remain attached securely until its desired removal. An additional advantage of this submission is the convenience this cup-like holder device provides when used for short or long term storage of paint brushes and when one wishes to keep specific type brushes associated with specific type paint cans.

This sufficiently different invention can be manufactured of light metal or plastic materials and can be washable and reusable or disposable. Said invention provides unexpected results and introduces a novel, non-obvious and innovative method of attachment directly onto the exterior of a paint can or such receptacle without the use of assemblies, holding straps or the dependency of the rim of a paint can. More specifically, this unitary cup-like holder device provides the opportunity to replace the lid on a paint can and provides a means to place or hold a dry or wet paint brush or such implement adjacent to and in immediate proximity of the paint can, during work in progress, a break or upon completion of a painting project.

This invention also provides a unique, novel, innovative alternative and safe solution to the problem encountered by holding a paint can in one hand and a paint brush in another while simultaneously ascending or descending a ladder.

While exemplary embodiments are described above, it is not intended that these embodiments describe all possible forms of the invention. Rather, the words used in the specification are words of description rather than limitation. It is understood that various changes may be made without departing from the spirit and scope of the invention. Additionally the features of various implementing embodiments may be combined for further embodiments of the invention.

I claim:

1. A unitary holder device that attaches to the outside of a paint can for holding a paint brush or such type implement comprised of a cup-like part with flanges on either side designed to go around the vertical surface of a paint can and hooks onto the paint can's wire handle ears.

2. The unitary holder device of claim 1 wherein one or more tabs and apertures extend from the device toward the paint can and flex against the paint can when the holder device is attached to a paint can to cause a tighter fit.

3. The unitary holder device of claim 1 wherein one or more tabs or apertures along the top surface are designed so that they flex against the surface of the paint can and ride up and over the protruding lip of the paint can as the device is being attached causing the device to be held securely just below the external top protruding lip of the paint can.

4. A child of the parent unitary holder device that attaches to the outside of a paint can for holding a paint brush or such type implement comprised of a cup-like part that can be securely attached to a paint can.
